(19) United States
(12) Patent Application Publication
(10) Pub. No.: US 2005/0076979 A1
(43) Pub. Date: Apr. 14, 2005

(54) Folding leather money holder

(76) Inventor: Charles Jacob Hyrman SR., Swartz Creek, MI (US)

Correspondence Address: CHARLES JACOB HYRMAN, SR, 2279 S. Morrish Road, Swartz Creek, MI, 48473, US

(21) Appl. No.: 10/929,738

(22) Filed: Aug. 30, 2004

Related U.S. Application Data
(60) Provisional application No. 60/499,189, filed on Sep. 2, 2003.

(51) Int. Cl. A45C 1/06; G07F 7/04

(52) U.S. Cl. 150/132

(57) ABSTRACT

My invention is the Folding Leather Money Holder. It is used for holding dollar bills of any denomination. It is compact and easily stored. It consists of a section of leather, or any other type of flexible material, which folds over itself three times, creating the small-compartmentalized piece, making the final folded piece 2.625″×2.125″. It works much like a money clip, only it is much easier to access your dollar bills one at a time, because you do not have to pullout all f the bills to access any one of them. By opening the two outside flaps, you can view all the dollar bills, and then add or remove one or multiple dollar bills without disrupting the other bills in the holder.

A Provisional Application was filed in September of 2003. The application number is 60/499,189. The filing date was Sep. 2, 2003. The confirmation number is 9960.

It is not Fed sponsored

### BACKGROUND INFORMATION

Background of the invention: Keeping paper money and credit cards in the same wallet can be cumbersome. Wallets and money clips go back to the early times of many, including pouches that hold bartering items. There is a need for a holder for just bills that is easily operated. The money clip is not ideal because you have to take all the money out of the clip, unfold it, retrieve the desired bill, then fold the money back up and put it back into the money clip. A need for a money holder similar to a money clip that would allow access to all monies without taking out the entire fold of money from it would be ideal. The idea of a money holder that opened up, much like the bill-holding sections of a wallet is perfect for this. Without having all the extra compartments for pictures or credit cards, this money holder would be slim, holding only paper money. The design needs to constitute the ability to view all bills at once, with the ability to retrieve any one bill desired.

### SUMMARY OF THE INVENTION

Considered broadly, wallets and other forms of money holders, such as money clips, are intended to hold dollar bills and in some cases, credit cards and photos. The Folding Leather Money Holder is a money holder that consists of a pattern with a flap at the bottom. This flaps folds over the money, and then each end of the money holder is folded on top of the flap, closing it. Any dollar bill desired can be easily accessed. It is much easier to carry than a cumbersome wallet. This pattern was cut out of leather, and then folded. Other materials can be used, such as cloth, snake hid, alligator hide, deer hide, ostrich hide, or any material commonly, or uncommonly used for wallets.

In the drawings, which form a part of this specification,
Drawing 1 An overview of the measurements and instructions on how to fold the money holder

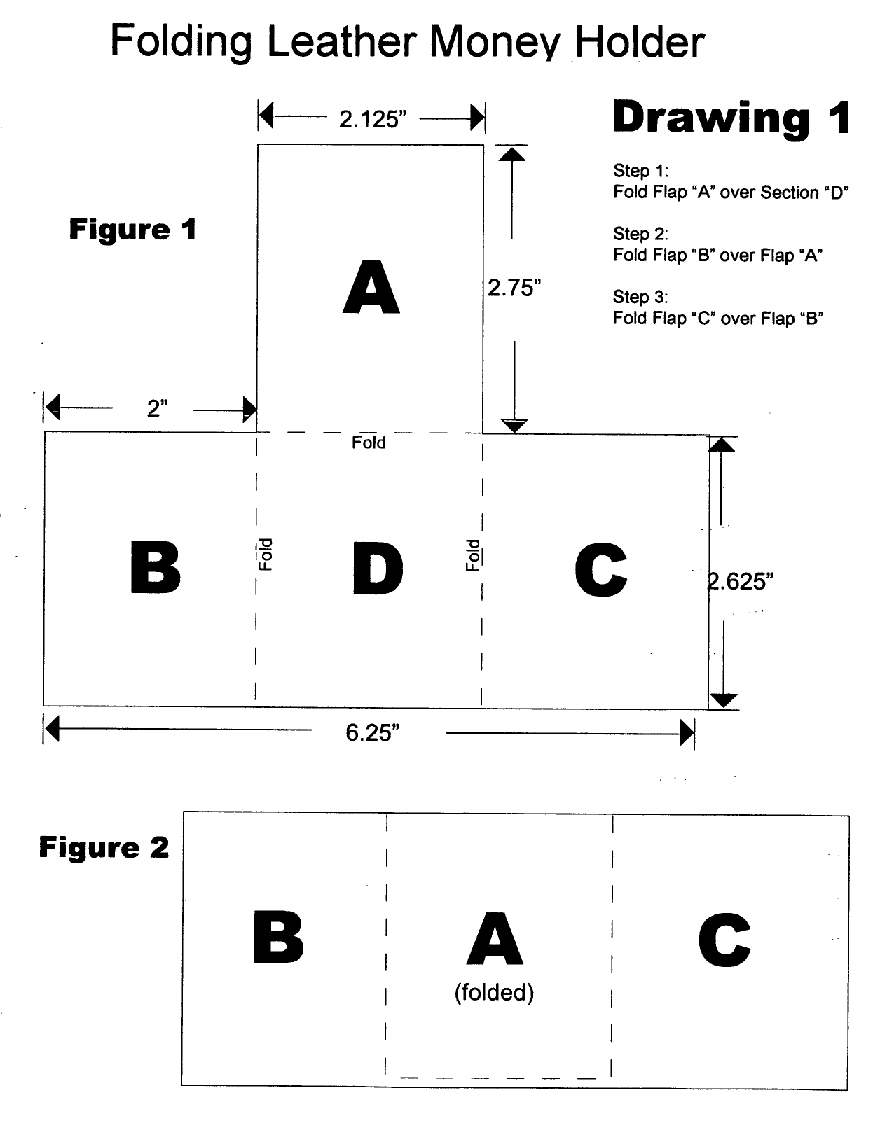

FIG. 1 is a view of the pattern used for the money holder, along with measurements, and folding directions;

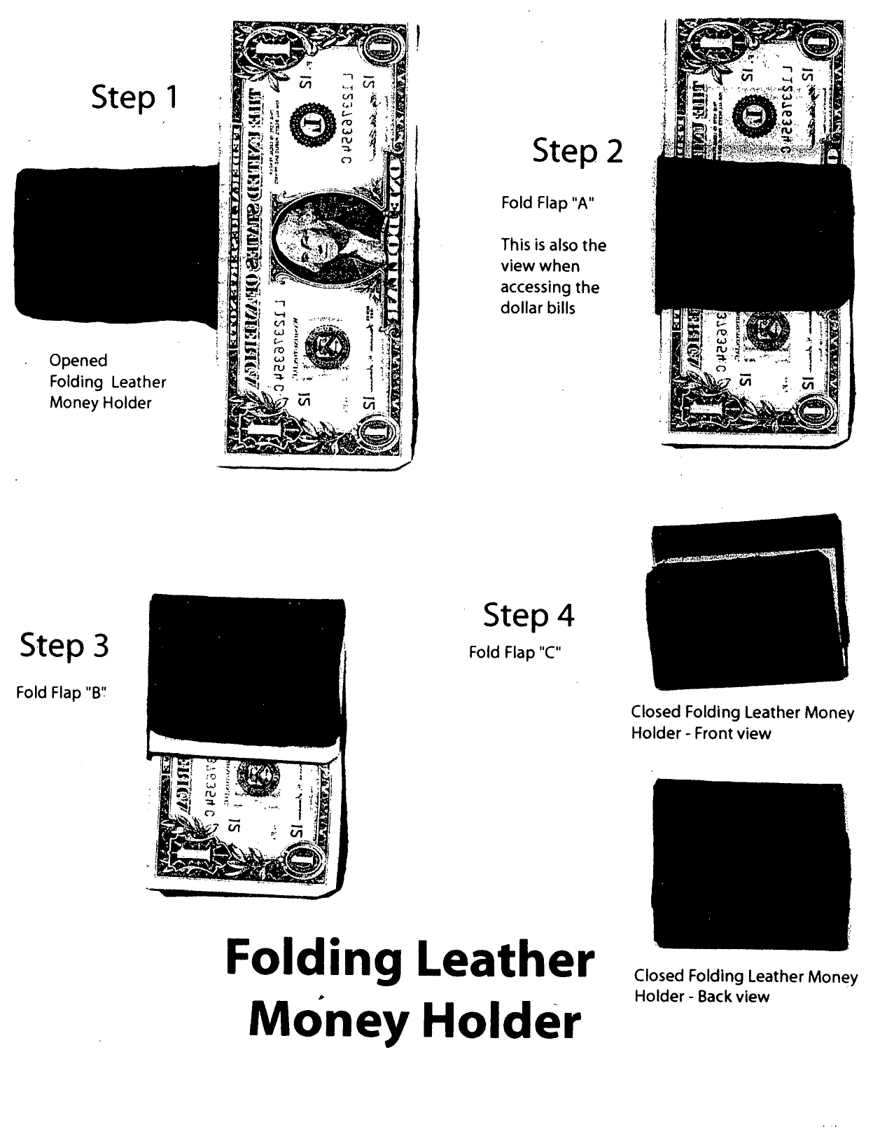

FIG. 2 is a view of the money holder with Flap “A” folded over;
Drawing 2 A systematic view of the money holder using a dollar bill as an example of its function

Step 1 is a view of the opened Folding Leather Money Holder with a dollar bill placed inside;

Step 2 is a view of the Folding Leather Money Holder with a dollar bills inside and Flap “A” folded over;

Step 3 is a view of the Folding Leather Money Holder with a dollar bill inside and Flap “B” folded over Flap “A”;

Step 4 is a view of the Folding Leather Money Holder with a dollar bill inside and Flap “C” folded over Flap “B”, which is, in effect, completely folded.

FIG. 3 A paper-working model of the Folding Leather Money Holder.

### DETAILED DESCRIPTION OF THE INVENTION

In the particularly advantageous embodiment of the invention illustrated, the entire Folding Money Holder comprises of one piece that is folded over itself to create a compact money holder. In drawing 1, in FIG. 1 the sketches show the pattern that is in a “T-formation” with the main part being 6.25″×2.625″ consisting of 3 creased sections, each labeled, parts B, C, and D, and the extended section, herein called a flap, or part A, is 2.125″×2.75″.

The Folding Leather Money Holder is cut from a piece of leather, or leather-like material, cloth or any other material desired, such as snake hide, alligator hide, pig skin, ostrich hide, or any other material, natural or man-made, into a “T-formation” with the measurements being 6.25″×2.625″, (main part), with an extended section, that is 2.25″×2.75″, (flap).

As shown in Drawing 1, FIG. 1, there are three folding creases marked; one is 2″ in from the outside of the main part, this will create main part section “B.” Another folding crease is 2.25″ in from the other end of the main part, this creates main part section “C.” The final crease is 2.75″ in from the outside of the extended part; this will be the flap, part “A”.

The folds are creased, then hammered or pressed to retain its folded shape easily.

Dollar bill(s) is (are) placed on the main part, Drawing 2, step 1. The flap is folded over onto part “D” of the main part as shown in Drawing 1, FIG. 2, along with Drawing 2, step 2.

Part “B” of the main part, is then folded over the flap; see Drawing 1, FIG. 1, along with Drawing 2, step 3. Lastly, the opposite end of the main part, part “C,” is folded over that last folded section, main part “B,” Drawing 1, FIG. 1, along with Drawing 2, step 4.

All folds in each step listed above, may need to be hammered or pressed to help maintain its folded shape. The type of material will vary the amount of hammering or pressing needed.

The final folded piece 2.625″×2.125″—see FIG. 3.

To retrieve the dollar bill(s) of any denomination, slide the dollar bill(s) from between flap “A” and the main part. Insert dollar bill by sliding them into the money holder between the flap “A” and the main part.

I have used this as a personal money holder since 1987. After I retired, I cut the first piece for the money holder out of leather leg protectors I used to wear at work. I have since made a pattern, and purchase leather and suede-like material to cut and make Folding Leather Money Holders today.

1. In a money holder that holds currency bills of any denomination, foreign or domestic;
A money holder comprising a flexible holder that folds down to one-third the size of a dollar bill, or its foreign counterparts;
A money holder the size of the bill currency when opened;
The material used can be natural or manufactured. Such examples can be, but are not limited to, leather, plastic, cloth, pig skin, alligator hide, ostrich hide;
